(19) United States
(12) Patent Application Publication
(10) Pub. No.: US 2014/0010096 A1
(43) Pub. Date: Jan. 9, 2014

(54) PORT MIRRORING IN DISTRIBUTED SWITCHING SYSTEMS

(71) Applicants: KESHAV KAMBLE, Fremont, CA (US); DAR-REN LEU, San Jose, CA (US); VIJOY PANDEY, San Jose, CA (US); CHANDARANI MENDON, San Jose, CA (US); DAVID ILES, San Jose, CA (US)

(72) Inventors: KESHAV KAMBLE, Fremont, CA (US); DAR-REN LEU, San Jose, CA (US); VIJOY PANDEY, San Jose, CA (US); CHANDARANI MENDON, San Jose, CA (US); DAVID ILES, San Jose, CA (US)

(73) Assignee: INTERNATIONAL BUSINESS MACHINES CORPORATION, Armonk, NY (US)

(21) Appl. No.: 13/544,236

(22) Filed: Jul. 9, 2012

(51) Int. Cl. H04L 12/26

(52) U.S. Cl. CPC H04L 43/0876
USPC 370/252; 370/355

(57) ABSTRACT

Port mirroring in a clustered network may be performed between a local switch and a remote switch. A port in the remote switch may be designated a mirrored port where data traffic passing there through can be copied and sent to a mirror-to-port on the local switch. In a virtual local area network (VLAN) environment, data frames of the copied traffic may include a VLAN header identifying the local switch so that routing of the data frames through the network may direct the data frames for monitoring at the local switch.

### BACKGROUND

The present invention relates to network management, and more specifically, to port mirroring in distributed switching systems.

When setting up a network, it may be desirable to cluster switch boxes from different physical locations to provide increased bandwidth and resources. Clustered switches may enable multiple switches, some in different locales, to provide the effect of one giant virtual switch. In a mesh network, for example, packets may be routed to any other functioning switch through various paths depending on factors such as traffic congestion and port availability. Thus, packet traffic may benefit from flexibility and robust packet routing among the multiple switches. The switches within a cluster may be set up as independent switches. However, in typical mesh networks, management of a switch may require an administrator to perform maintenance and repair at the switch. Monitoring of traffic at a port on any switch is typically performed at the switch.

### SUMMARY

According to one embodiment of the present invention, a network switch comprises a data traffic port configured as a mirrored port; and a processor configured to: operate the switch within a distributed, non-blocking fabric, attach a virtual local area network (VLAN) header to a data packet, the VLAN header pointing to a remote mirror-to-port on a remote switch in the distributed, non-blocking fabric including the network switch, and attach an outer media access control (MAC) address to the data packet.

According to another embodiment of the present invention, a network system comprises a plurality of network switches connected to one another in a distributed, non-blocking fabric; a first switch of the plurality of network switches including a local mirrored port; and a second switch of the plurality of network switches including a remote mirror-to-port configured to monitor ingress and egress traffic in the local mirrored port.

According to yet another embodiment of the present invention, a process of monitoring port traffic within a switching network comprises configuring a plurality of network switches to communicate with one another in a virtual local area network (VLAN); selecting one of the plurality of network switches as an egress switch; selecting a first port in a remote switch as a mirrored port, wherein the remote switch is remote from the egress switch; selecting a second port in the egress switch as a mirror-to-port wherein the mirror-to-port is configured to monitor data traffic through the mirrored port; attaching, at the remote switch, a VLAN header to data frames copying data packets passing through the mirrored port; sending data frames with the VLAN header, from the remote switch, through the VLAN to the egress switch using the VLAN header; receiving at the mirror-to-port, the data frames; removing the VLAN header from the data frames; and monitoring the data frames at an interface connected to the master switch.

According to still yet another embodiment of the present invention, a computer program product for monitoring port traffic in a clustered switching network, the computer program product comprising a computer readable non-transitory storage medium having computer readable program code embodied therewith, the computer readable program code being configured to: enable one of a plurality of routing bridges in the clustered switching network as a management point; configure a remote routing bridge for management and control by the management point; select a first port in the remote routing bridge as a mirrored port; select a second port in the management point as a mirror-to-port configured to receive mirrored frames of the mirrored port; send the mirrored data frames, from the remote routing bridge, through the clustered switching network, to the management point; receive the data frames at the mirror-to-port; and monitor the data frames at an interface connected to the management point.

### BRIEF DESCRIPTION OF THE SEVERAL VIEWS OF THE DRAWINGS

FIG. 1 is a block diagram of a clustered network according to an exemplary embodiment of the present invention;

FIG. 2 is block diagram of the clustered network of FIG. 1 connected to external networking elements;

FIG. 3 is a flowchart of a process of initializing port mirroring in the clustered network of FIG. 1 according to another exemplary embodiment; and

FIG. 4 is a flowchart of a process of remote port mirroring in the clustered network of FIG. 1 according to yet another exemplary embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As generally described herein, port mirroring in a clustered switching network provides an administrator access to monitoring data traffic on any switch in the network from a management point. Port mirroring may be local or from a remote switch. Data traffic copied from a monitored port may be embedded with instructions providing the copied data with routing means through the clustered network for monitoring by the management point.

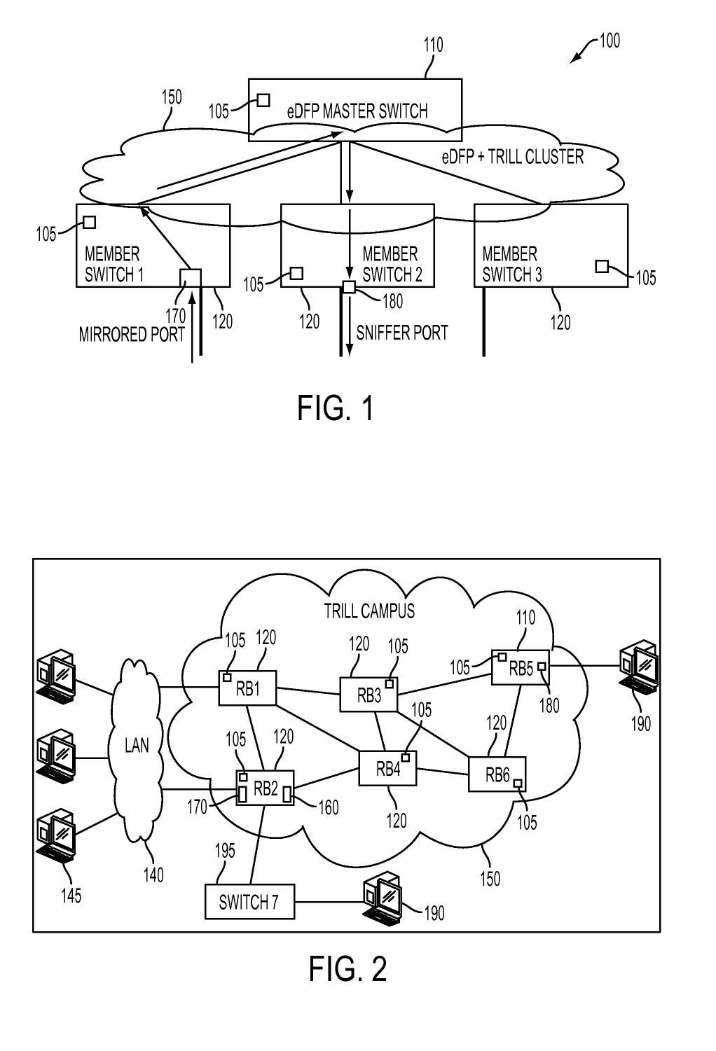

Referring now to FIG. 1, a switching network 100 is shown according to an exemplary embodiment of the present invention. The switching network 100 may include a plurality of switches 110, 120. The switches 110, 120 may be clustered into a virtual switch 150. The virtual switch 150 may be configured as a non-blocking, distributed fabric using a Transparent Interconnect of Lots of Links (TRILL) standard. The virtual switch 150 may also be referred to as a TRILL campus 150. Communication between the switches 110, 120 may be performed using a proprietary protocol (eDFP). The switches 110, 120 may each include processors 105 configured with identical operating protocols. For example, each processor 105 may control and manage data access of a remote switch 120 as though said processor 105 were resident on said remote switch 120. In this manner, the clustering of switches 110, 120 may provide the appearance of a single switch to entities interfacing any switch 110, 120 from outside the virtual switch 150.

When interfaced by an administrator, the switches 110, 120 may be configured for access from any switch on the virtual switch 150. The administrator may designate as master, the switch 110 and label the remaining switches as member switches 120. For sake of illustration, the virtual switch 150 is described in the context of having only one master switch 110 however any member switch 120 may be accessed and enabled with the responsibilities of being a master switch 110 in a distributed network environment. From the master switch 110, the administrator may communicate, access, and control any of the other switches 120. For example, an administrator (not shown) wanting to monitor performance on a port may access one of the member switches 120 and enable a port to operate as a “sniffer” or “mirror-to-port” 180. A targeted port 170 may be mirrored so that data traffic through the port 170 may be copied in data packets as frames (also referred to as data frames or mirrored frames) and sent to the mirror-to-port 180.

Referring now to FIG. 2, users 145 accessing the TRILL campus 150 through a LAN 140 is shown. In one exemplary embodiment, the switches 110, 120 may be routing bridges (shown as RB1, RB2, RB3, RB4, RB5, and RB6). While six routing bridges are show, it will be understood that the TRILL campus 150 may include more or fewer switches 110, 120.

In one embodiment, local port mirroring may be performed. For example, an administrator, through an interface 190, may access and control RB2. RB2 may include a port 170 that is processing ingress and/or egress network traffic from the LAN 140. The administrator may desire to monitor the traffic on port 170. From a switch 195 outside the TRILL campus 150, the administrator may designate on RB2 port 170 as a mirrored port. In this manner, data copied from port 170 may be sent accessed through switch 7 from local access port 160 without modification.

In another embodiment, the TRILL campus 150 may be a Virtual Local Area Network (VLAN) configured for remote port mirroring. In some embodiments, the VLAN may only be a portion of the TRILL campus 150 where port mirroring is desired. For example, an administrator may again desire to access RB2 (referred to interchangeably as ingress switch 120 or remote ingress switch 120). However, the administrator may be remote from RB2. In a uni-cast method, a single switch, for example RB5, may be the egress point for mirrored traffic. In a multi-cast method, multiple switches (a distribution tree) may be designated and configured as egress points. Each of the routing bridges (e.g., in a tree including RB5) may include mirror-to-ports receiving the mirrored traffic. Under a uni-cast method, a port-bitmap for local egress ports on the egress routing bridge (RB5) may be configured. Under a multi-cast method, a port-bitmap for local egress ports on all the routing bridges in the tree may be configured. When remote, the administrator may interface with the nearest switch 120. For sake of illustration, RB5 may be considered the nearest accessible point in virtual switch 150 to the administrator.

The administrator may designate RB5 as a master switch 110 and configure RB5 as a management point for port mirroring. The master switch 110 (RB5) or another member switch 120 remote from RB2 may be designated as an egress switch. The egress switch (110 or 120) may be configured for operation as a destination receiving mirrored data. For example, a VLAN address, a MAC address, and a TRILL address may be associated with the RB5. The master switch 110 may also configure a port 180 on the egress switch (110 or 120) to operate as a mirror-to-port.

From the master switch 110, port 170 may be accessed and provided with instructions configuring the port as a mirrored port. The ingress switch 120 (RB2) may copy data traffic through the port 170 into data frames that may be routed through any of the other member switches 120 (RB1, RB3, RB4, RB6) between RB2 and RB5. To direct the copied data frames to RB5, the remote ingress switch 120 (RB2) may attach a VLAN header to the frame packets. At the remote ingress switch 120 (RB2), the processor 105 may direct a networking processing chip to attach a TRILL header to the data frames. The TRILL header may contain information instructing the packets to proceed to a subsequent member switch 120 en route to the egress switch (110 or 120). Each member switch 120 may include logic determining a pathway for data to travel through the TRILL campus 150. The processor 105 at each member switch 120 may change the outer MAC header to the data frames. The destination MAC of the outer MAC header will be the MAC address of the next hop RB for a mirrored frame. In some exemplary embodiments, an access control list (ACL) may be attached to the data frames allowing traffic to be redirected out of the mirror-to-port.

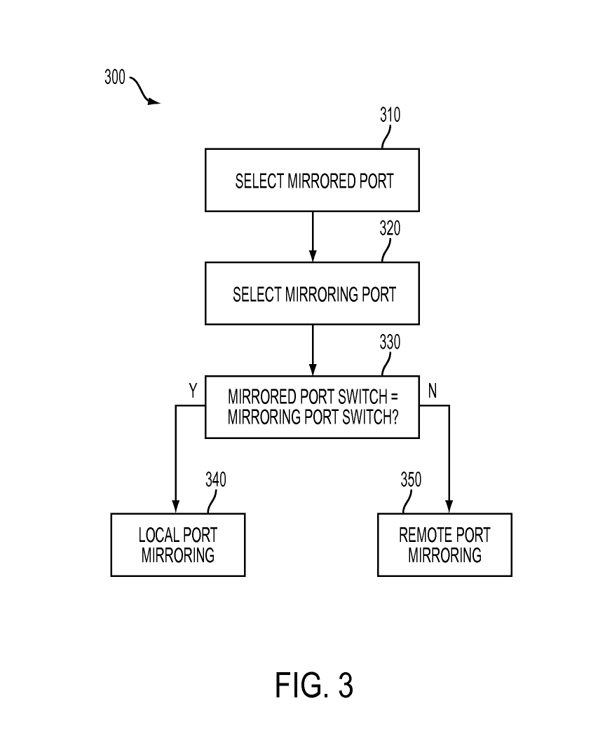

Referring now to FIG. 3, a process (300) of initializing port mirroring in a VLAN 150 is shown. An administrator may select (310) a port whose data traffic may be mirrored. The administrator may select (320) which port may receive the mirrored data. The administrator may determine (330) whether the mirrored port and the mirroring port (mirror-to-port) are on the same switch. If the mirrored port and mirror-to-port are on the same switch, then local port mirroring (340) may be initialized. If the mirrored port and mirror-to-port are not on the same switch, then remote port mirroring (350) may be initialized.

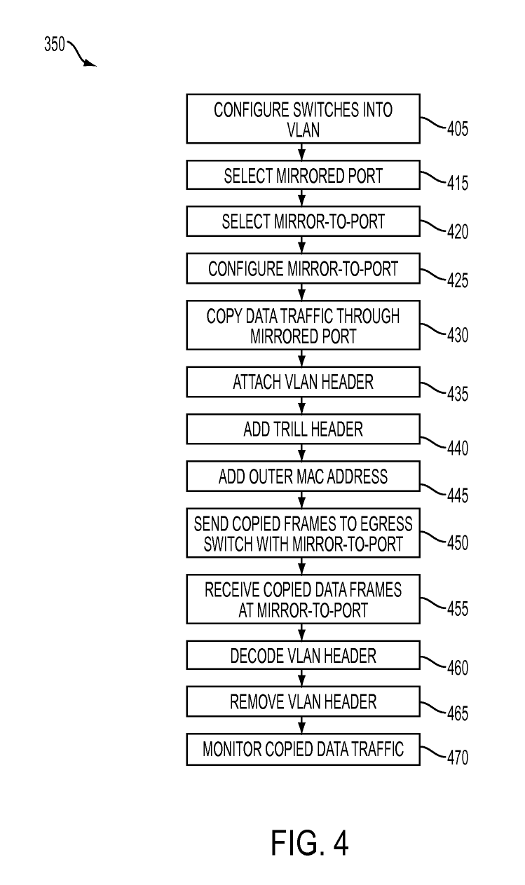

Referring now to FIG. 4, a process (350) of remote port mirroring within the switching network 100 is shown. An administrator may configure (405) the network switches 110, 120 to communicate with each other for port mirroring in a virtual switch 150 environment. During initial configuration, processors 105 at each switch 110, 120 may be embedded with instructions to configure ports as either a mirrored port 170 or a mirror-to-port 180. The administrator may select (415) a port 170 as a mirrored port in a switch 120 that is remote from the egress switch (110 or 120). The administrator may select (420) a port 180 in the egress switch (110 or 120) as a mirror-to-port. The administrator may configure (425) the mirror-to-port 180 to receive data frames copying data traffic passing through the mirrored port 170.

The remote ingress switch 120 may copy (430) data traffic through port 170 into data frames and embed the data frames with instructions to navigate through the VLAN 150 to the mirror-to-port 180. For example, the processor 105 may attach (435) a VLAN header to the data frames. The VLAN header may correspond to the management point as a physical interface within the clustered switching network 100. The processor 105 may also attach (440) a TRILL header to the data frames. The TRILL header may point the data frames to a next member switch 120 en route to the egress switch (110 or 120). The processor 105 may also attach (445) a MAC address to the data frames, pointing to the next hop RB.

The processor 105 may send (450) the data frames through the VLAN 150 to the mirror-to-port 180 using the TRILL logic. The egress switch (110 or 120) may receive (455) the data frames at the mirror-to-port 180. The processor 105, at the egress switch (110 or 120), may decode (460) and remove (465) the VLAN header from the data frames. The administrator may monitor (470) the data frames at interface 190.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A network switch, comprising:
a data traffic port configured as a mirrored port; and
a processor configured to:
operate the switch within a distributed, non-blocking fabric,
attach a virtual local area network (VLAN) header to a data packet, the VLAN header pointing to a remote mirror-to-port on a remote switch in the distributed, non-blocking fabric including the network switch, and
attach an outer media access control (MAC) address to the data packet.

2. The network switch of claim 1, wherein the processor is configured to operate the switch under a Transparent Interconnect of Lots of Links (TRILL) standard.

3. The network switch of claim 2, wherein the processor is configured to attach a TRILL header to the data packet providing routing instructions for the data packet to travel through the distributed, non-blocking fabric to the remote mirror-to-port.

4. A network system, comprising:
a plurality of network switches connected to one another in a distributed, non-blocking fabric;
a first switch of the plurality of network switches including a local mirrored port; and
a second switch of the plurality of network switches including a remote mirror-to-port configured to monitor ingress and egress traffic in the local mirrored port.

5. The network system of claim 4, wherein the plurality of network switches are operated under a Transparent Interconnect of Lots of Links (TRILL) standard.

6. The network system of claim 4, including a processor in the first switch that is configured to attach a virtual local area network header (VLAN) to data packets mirroring traffic passing through the local mirrored port, the VLAN header pointing to the remote mirror-to-port.

7. The network system of claim 6, wherein the processor is configured to attach an outer media access control (MAC) address to the data packets mirroring traffic passing through the local mirrored port, the MAC address pointing to the second switch.

8. The network system of claim 4, wherein the plurality of switches are routing bridges.

9. The network system of claim 4, wherein each of the plurality of network switches is configured to control and manage any other switch in the distributed, non-blocking fabric.

10. A process of monitoring port traffic within a switching network, comprising:
configuring a plurality of network switches to communicate with one another in a virtual local area network (VLAN);
selecting one of the plurality of network switches as an egress switch;
selecting a first port in a remote switch as a mirrored port, wherein the remote switch is remote from the egress switch;
selecting a second port in the egress switch as a mirror-to-port wherein the mirror-to-port is configured to monitor data traffic through the mirrored port;
attaching, at the remote switch, a VLAN header to data frames copying data packets passing through the mirrored port;
sending data frames with the VLAN header, from the remote switch, through the VLAN to the egress switch using the VLAN header;
receiving at the mirror-to-port, the data frames;
removing the VLAN header from the data frames; and
monitoring the data frames at an interface connected to the master switch.

11. The process of claim 10 including attaching, at the remote switch, a Transparent Interconnect of Lots of Links (TRILL) header to the data frames, the TRILL header pointing the data frames to a next switch en route to the egress switch.

12. The process of claim 10 including attaching, at the remote switch, an outer media access control (MAC) address to the data frames, the MAC address pointing to the egress switch.

13. The process of claim 10, wherein the plurality of switches are routing bridges in a Transparent Interconnect of Lots of Links (TRILL) based configuration.

14. The process of claim 10, wherein sending the data frames through the VLAN is performed under a TRILL uni-cast method.

15. The process of claim 10, wherein sending the data frames through the VLAN is performed under a TRILL multi-cast method.

16. A computer program product for monitoring port traffic in a clustered switching network, the computer program product comprising a computer readable non-transitory storage medium having computer readable program code embodied therewith, the computer readable program code being configured to:
enable one of a plurality of routing bridges in the clustered switching network as a management point;
configure a remote routing bridge for management and control by the management point;
select a first port in the remote routing bridge as a mirrored port;
select a second port in the management point as a mirror-to-port configured to receive mirrored frames of the mirrored port;
send the mirrored data frames, from the remote routing bridge, through the clustered switching network, to the management point;
receive the data frames at the mirror-to-port; and
monitor the data frames at an interface connected to the management point.

17. The computer program product of claim 16, the computer readable program code being configured to attach, at the remote routing bridge, a virtual local area network (VLAN) header to the mirrored data frames, the VLAN header identifying the management point as a physical interface within the clustered switching network.

18. The computer program product of claim 17, the computer readable program code being configured to decode, at the remote routing bridge, the VLAN header from the mirrored frames.

19. The computer program product of claim 17, the computer readable program code being configured to provide a port-bitmap on egress ports in each of the routing bridges to attach the VLAN header and direct the mirrored frames toward the remote routing bridge.

20. The computer program product of claim 16, the computer readable program code being configured to predetermine a routing tree, from the remote routing bridge to the management point, through the plurality of routing bridges.
